(19) United States
(12) Patent Application Publication
(10) Pub. No.: US 2014/0232741 A1
(43) Pub. Date: Aug. 21, 2014

(54) Image Processing Method and Display Apparatus Using the Same

(71) Applicant: SAMSUNG DISPLAY CO., LTD., Yongin-City (KR)

(72) Inventors: Jae-Suk Choi, Uijeongbu-Si (KR); Gwangho Nam, Asan-Si (KR); Hoisik Moon, Asan-Si (KR); Byoung Seok Yoo, Yongin-Si (KR); Chang-Soo Lee, Cheonan-Si (KR); Min-Yup Chae, Cheonan-Si (KR); Hak-Mo Choi, Seoul (KR)

(21) Appl. No.: 13/941,013

(22) Filed: Jul. 12, 2013

(30) Foreign Application Priority Data
Feb. 19, 2013 (KR) 10-2013-0017628

(51) Int. Cl. G09G 5/02

(52) U.S. Cl. CPC G09G 5/028
USPC 345/600

(57) ABSTRACT

An image processing method includes receiving an RGB data, converting the RGB data to an HSV data configured to include hue, saturation, and value compensating for the HSV data on a basis of a hue data of the HSV data, and converting the compensated HSV data to a compensated RGB data. The compensating of the HSV data includes reading out a compensation data corresponding to the hue data from a look-up table and compensating for the HSV data using the compensation data. The data are compensated on the basis of the hue in the HSV color space and the saturation and value are preserved, and thus the image, e.g., the memory color like the skin color, may be prevented from being distorted.

### CROSS-REFERENCE TO RELATED APPLICATION

This U.S. non-provisional patent application claims priority under 35 U.S.C. §119 to Korean Patent Application No. 10-2013-0017628, filed on Feb. 19, 2013, the contents of which are hereby incorporated by reference in its entirety.

### TECHNICAL FIELD

The present disclosure relates to an image processing method and a display apparatus and more particularly, to an image processing method and a display apparatus using the same.

### DISCUSSION OF THE RELATED ART

In recent years, various technologies have been developed to expand a color gamut of an image displayed in a display apparatus.

Viewers of display apparatuses have been shown to be particularly sensitive to distortions in displayed skin color.

Various methods have been suggested for compensating for distortions in displayed skin color, but these methods require excessive matrix calculations and are thus computationally expensive.

### SUMMARY

The present disclosure provides an image processing method capable of preventing image colors from being distorted during a color gamut mapping process.

The present disclosure provides a display apparatus capable of displaying an image using the image processing method.

Embodiments of the inventive concept provide an image processing method including receiving RGB data. The RGB data is converted to an HSV data configured to include a hue, a saturation, and a value. The HSV data is compensated for on a basis of a hue data of the HSV data. The compensated HSV data is converted to a compensated RGB data.

Embodiments of the inventive concept provide a method for processing image data including receiving image data represented in an RGB color space, the received image data having a first color gamut. The received image data represented in the RGB color space is converted into an HSV color space, the converted image data represented in the HSV color space having a second color gamut that is less robust than the first color gamut. Changes of skin tone within the converted image data represented in the HSV color space are compensated for based on a hue data of the converted image data represented in the HSV color space. The compensated image data represented in the HSV color space is converted back into the RGB color space.

The compensating of the HSV data may include reading out a compensation data corresponding to the hue data from a look-up table and compensating for the HSV data using the compensation data.

The look-up table may be a one-dimensional look-up table in which the hue-difference data, the saturation-difference data, and the value-difference data according to the hue data are stored.

Embodiments of the inventive concept provide a display apparatus including an RGB-to-HSV converter, a compensator, an HSV-to-RGB converter, and a display unit. The RGB-to-HSV converter receives RGB data and converts the RGB data to an HSV data. The compensator compensates for the HSV data on a basis of a hue data of the HSV data. The HSV-to-RGB converter receives the compensated HSV data and converts the compensated HSV data to a compensated RGB data. The display unit receives the compensated RGB data and displays an image on a basis of the compensated RGB data.

According to the above, the data are compensated on the basis of the hue in the HSV color space and the saturation and value are preserved, and thus the image, e.g., the memory color like the skin color, may be prevented from being distorted.

In addition, since the data may be compensated using the one-dimensional look-up table, the amount of calculations performed is reduced and a size of the memory is reduced.

### BRIEF DESCRIPTION OF THE DRAWINGS

The above and other aspects of the present disclosure will become readily apparent by reference to the following detailed description when considered in conjunction with the accompanying drawings wherein:

FIG. 1 is a flowchart showing an image processing method according to an exemplary embodiment of the present disclosure;

FIG. 2 is a view showing a look-up table according to an exemplary embodiment of the present disclosure;

FIG. 3A is a view showing hue-difference data according to hue-angle data;

FIG. 3B is a view showing saturation-difference data according to hue-angle data;

FIG. 3C is a view showing value-difference data according to hue-angle data;

FIG. 4A is a view showing hue-difference of images according to hue-angle data before and after data compensation is performed;

FIG. 4B is a view showing saturation-difference of images according to hue-angle data before and after data compensation is performed;

FIG. 4C is a view showing value-difference of images according to hue-angle data before and after data compensation is performed;

FIG. 4D is a view showing a difference between images according to hue-angle data before and after data compensation is performed; and

FIG. 5 is a block diagram showing a display apparatus according to an exemplary embodiment of the present disclosure.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. Like numbers may refer to like elements throughout the disclosure and the figures.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. Hereinafter, the present invention will be explained in detail with reference to the accompanying drawings.

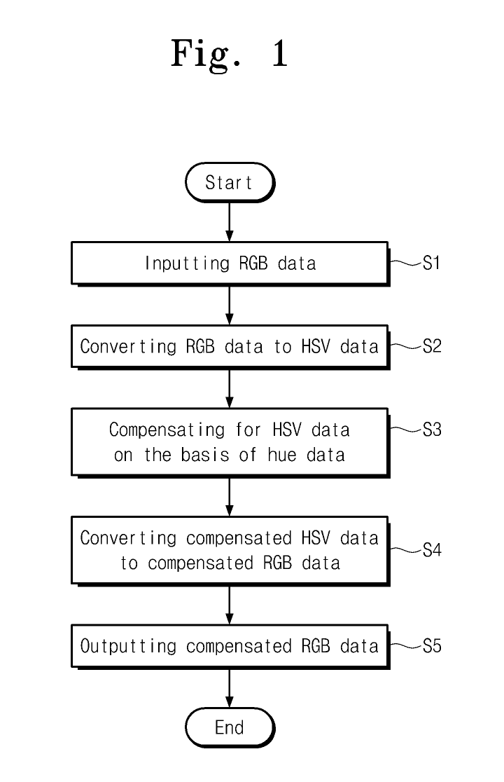

FIG. 1 is a flowchart showing an image processing method according to an exemplary embodiment of the present disclosure.

Referring to FIG. 1, RGB data RGB are received (S1). The RGB data RGB are data represented within a color space configured to include values for a red color, a green color, and a blue color.

The RGB color space defines colors using a property that a white color is obtained by mixing the three primary colors, i.e., the red, green, and blue colors. Thus any desired color may be represented in terms of a value for red, a value for green, and a value for blue that combine to provide the desired color.

The color gamut for a display device refers to the number and shades of unique colors that the display device is capable of accurately displaying. A color gamut for a particular display device may be limited to a smaller set of colors than what the RGB color space may define.

In general, since a color gamut of a display panel is limited, a process of mapping the RGB data RGB to the color gamut of the display panel may be used. In this case, the RGB data ROB are data-compensated on the basis of the red, green, and blue colors, and thus calculations may be computationally expensive.

The RGB data are converted to HSV data HnSnVn (S2). The HSV data HnSnVn are data of color space configured to include hue, saturation, and value. The HSV data HnSnVn may be divided into hue data Hn, saturation data Sn, and value data Vn. Here, the hue data Hn include angle information of the hue in the HSV color space and range information from about 0 degree to about 360 degrees.

The HSV color space defines color using hue, saturation, and value on the basis of an intuitive view.

When the HSV data HnSnVn are displayed on the display panel without being data-compensated, distortion may occur to the color of the image. In this case, the data corresponding to the distortion of the image may be represented as compensation data dHdSdV in the HSV color space. The compensation data dHdSdV may be represented as hue-difference data dH, saturation-difference data dS, and value-difference data dV in the HSV color space.

The HSV data HnSnVn are compensated based on the hue data Hn (S3).

According to exemplary embodiments of the present invention, the HSV data HnSnVn may be compensated exclusively by adjusting the hue data Hn since the human eyes react more sensitively to the hue-difference than to the saturation-difference or the value-difference.

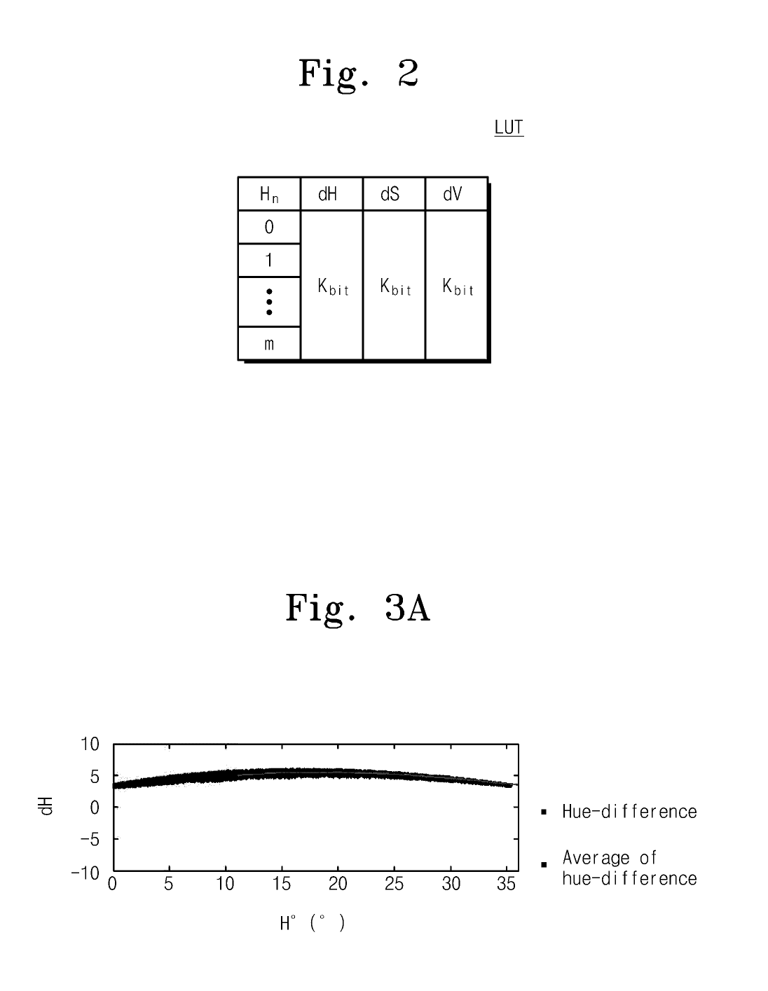

FIG. 2 is a view showing a look-up table according to an exemplary embodiment of the present disclosure.

Referring to FIGS. 1 and 2, the HSV data HnSnVn may be compensated by reading out and calculating the hue-difference data dH, the saturation-difference data dS, and the value-difference data dV from the look-up table LUT, which correspond to the hue data Hn.

The look-up table LUT stores the hue-difference data dH, the saturation-difference data dS, and the value-difference data dV according to the hue data Hn. The look-up table LUT is a one-dimensional look-up table in accordance with the hue data Hn.

The hue data Hn have value from 0 to m (where m is a positive integer) according to a number of data bits.

Each of the hue-difference data dH, the saturation-difference data dS, and the value-difference data dV, which are stored in the look-up table LUT, is expressed as a K bit number (where K is a positive integer), e.g., 6 bits.

The HSV data HnSnVn are compensated when the hue data tin satisfies a first range. The hue-difference data dH, the saturation-difference data dS, and the value-difference data dV, which correspond to the hue data Hn separated from the first range, may thus be stored as 0.

The first range may be a range corresponding to the skin color of human beings. In the HSV color space, the range corresponding to the skin color of human beings may include ranges respectively corresponding to the hue H, the saturation S, and the value V. However, since the range of the hue H is the most important, the first range will be described on the assumption that the first range is limited to the hue H. The first range may be determined by both the human psychological perception and the characteristic of display.

The first range is 0°≦H°≦50°, for example, 14°≦H°≦28°. Here, the H° is a hue-angle data obtained by converting the hue data Hn to an angle.

According to an exemplary embodiment, the compensation for the HSV data HnSnVn will be described only when the hue data Hn corresponds to the first range, but the invention is not limited to this particular example. Multiple ranges may be further set to compensate for other memory colors besides skin color. The HSV data HnSnVn may be compensated by the following Equation 1.

HoSoVo=HnSnVn+dHdSdV Equation 1

In Equation 1, HnSnVn denotes the HSV data, dHdSdV denotes the compensation data, and HoSoVo denotes compensated HSV data.

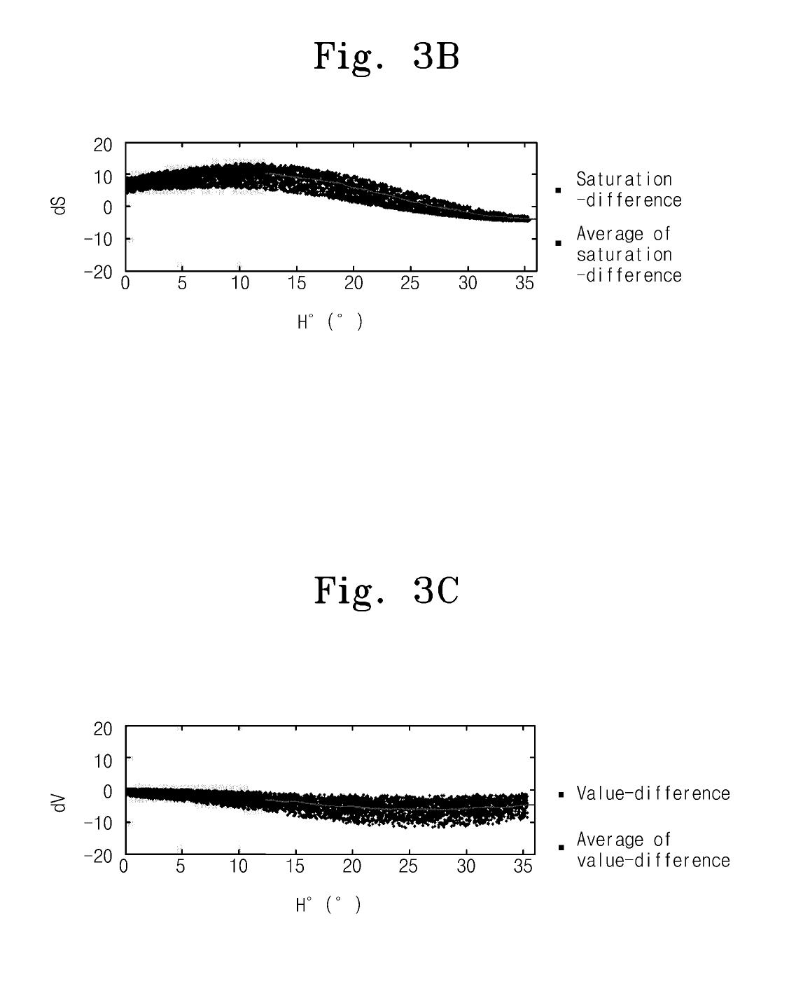

FIGS. 3A to 3C show an example of setting the hue-difference data dH, the saturation-difference data dS, and the value-difference data dV of the look-up table LUT in accordance with exemplary embodiments of the present invention. In detail, FIG. 3A is a view showing the hue-difference data dH according to the hue-angle data H°, FIG. 3B is a view showing the saturation-difference data dS according to the hue-angle data H°, and FIG. 3C is a view showing the value-difference data dV according to the hue-angle data H°.

FIGS. 3A to 3C show results that may be obtained by simulated distributions of the hue-difference, the saturation-difference, and the value-difference with respect to 5000 points randomly selected from the hue-angle data H° in the skin color area.

In addition, FIGS. 3A to 3C shows an average value of each of the hue-difference, the saturation-difference, and the value-difference. The average value of the distribution of the hue-difference, the average value of the distribution of the saturation-difference, and the average value of the distribution of the value-difference may be digitized and stored in the look-up table LUT (refer to FIG. 2) as the hue-difference data dH, the saturation-difference data dS, and the value-difference data dV, respectively.

In this case, the hue-difference data dH are used to compensate for the hue data Hn, the saturation-difference data dS used to preserve original saturation after the hue is compensated, and the value-difference data dV used to preserve original value after the hue is compensated.

Referring to FIG. 1 again, the compensated HSV data HSV are converted to compensated RGB data RGB′ (S4).

The compensated RGB data RGB′ are output (S5). The compensated RGB data RGB′ are converted to data voltages in the display apparatus and displayed as the images.

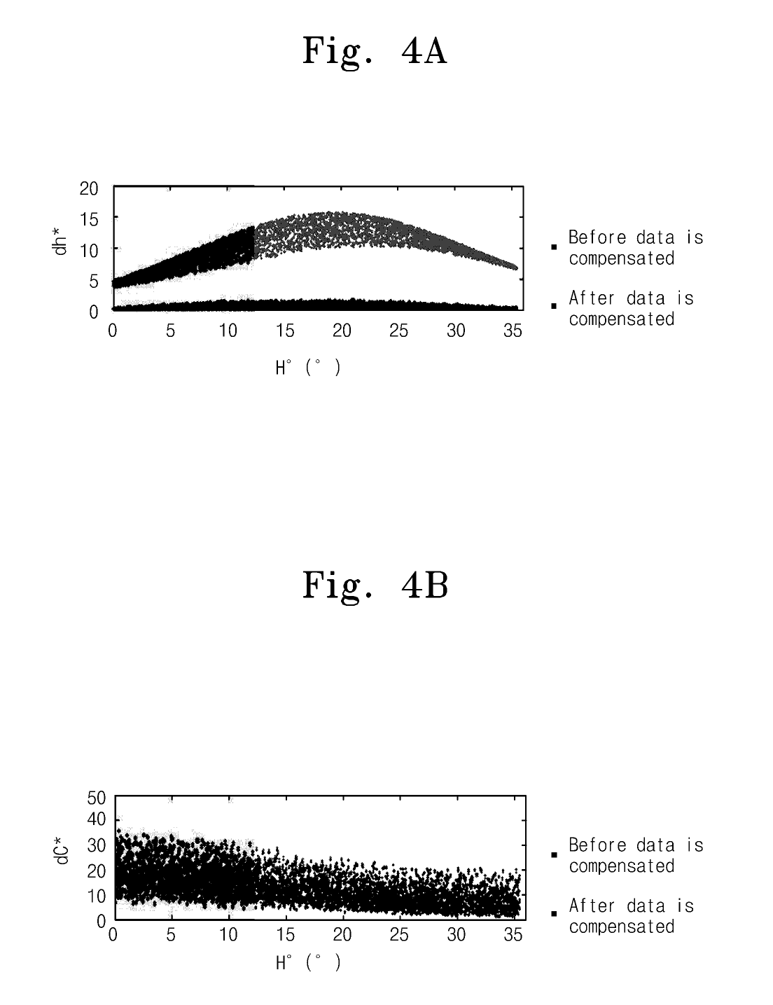

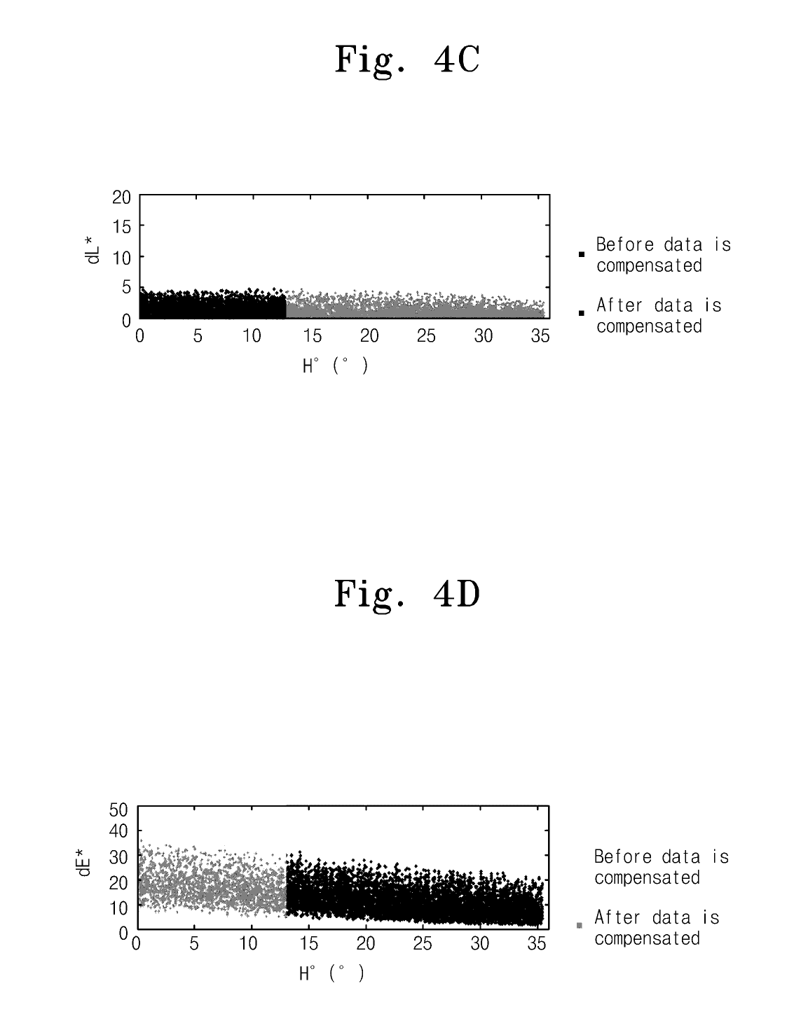

FIG. 4A is a view showing the hue-difference dh* of the images according to the hue-angle data H° before and after the data compensation is performed. FIG. 4B is a view showing the saturation-difference dC* of the images according to the hue-angle data H° before and after the data compensation is performed. FIG. 4C is a view showing the value-difference dL* of the images according to the hue-angle data H° before and after the data compensation is performed. FIG. 4D is a view showing an image-difference, dE* between the images according to the hue-angle data H° before and after the data compensation is performed.

FIGS. 4A to 4D show results that may be obtained by simulated distributions of the hue-difference, the saturation-difference, and the value-difference with respect to 5000 points randomly selected from the hue-angle data H° in the skin color area in accordance with exemplary embodiments of the present invention.

Referring to FIG. 4A, the hue-difference dh* of the images is reduced after the data compensation is performed when compared to that of the images before the data compensation is performed. Referring to FIGS. 4B and 4C, however, there is no perceivable variation in the saturation-difference dC* of the images and the value-difference dL* of the images before and after the data compensation is performed.

These are results may be obtained by selectively compensating for the hue data on the basis of the hue data using the look-up table and preserving the saturation data and the value data.

In FIG. 4D, the image-difference dE* of the images is defined as a distance on three-dimensional space of the hue, saturation, and value. A variation exists in the image-difference dE* due to the hue-difference dh* of the images before and after the data compensation is performed.

According to an image processing method of the present disclosure, the data are compensated on the basis of the hue in the HSV color space and the saturation and value are preserved, and thus the image, e.g., the memory color like the skin color, may be substantially prevented from being distorted. In addition, since the data may be compensated using the one-dimensional look-up table, the computational burden of image compensation becomes smaller and a size of the memory required is reduced.

Hereinafter, an example of the display device will be described.

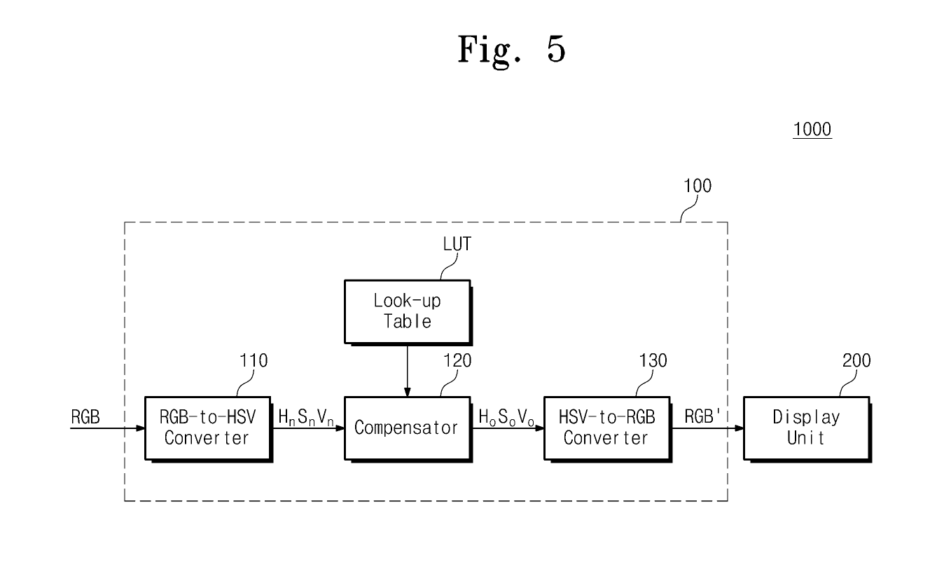

FIG. 5 is a block diagram showing the display apparatus 1000 according to an exemplary embodiment of the present disclosure.

Referring to FIG. 5, the display apparatus 1000 includes an image processing unit 100 and a display unit 200.

The image processing unit 100 may be used to perform the processes described above with reference to FIGS. 1 and 2.

The image processing unit 100 includes an RGB-to-HSV converter 110, a compensator 120, an HSV-to-RGB converter 130, and a look-up table LUT.

The RGB-to-HSV converter 110 receives the RGB data RGB from an external source (not shown). The RGB-to-HSV converter 110 converts the RGB data RGB to the HSV data HnSnVn and applies the HSV data HnSnVn to the compensator 120.

The look-up table LUT is substantially the same as the look-up table described above with reference to FIG. 2.

The compensator 120 compensates for the HSV data HnSnVn on the basis of the hue data Hn. For example, the compensator 120 reads out the hue-difference data dH, the saturation-difference data dS, and the value-difference data dV, which correspond to the hue data Hn, from the look-up table LUT and calculates the hue-difference data dH, the saturation-difference data dS, and the value-difference data dV with the HSV data HnSnVn.

The compensator 120 generates the compensated HSV data HoSoVo and applies the compensated HSV data HoSoVo to the HSV-to-RGB converter 130.

The HSV-to-RGB converter 130 converts the compensated HSC data HoSoVo to the compensated RGB data RGB′ and applies the compensated RGB data RGB′ to the display unit 200.

Although not shown in FIG. 5, the display unit 200 includes a driving unit and a display panel.

The driving unit includes a timing controller, a data driver, and a gate driver. The driving unit receives the compensated RGB data RGB′ and converts the compensated RGB data RGB′ to the data voltages, and then the driving unit applies the data voltages to the display panel.

The display panel displays the image corresponding to the data voltage. The display panel may be formed from various display panels, such as an organic light emitting display panel, a liquid crystal display panel, a plasma display panel, an electrophoretic display panel, an electrowetting display panel, etc.

Although exemplary embodiments of the present invention have been described, it is understood that the present invention should not be limited to these exemplary embodiments but various changes and modifications can be made by one ordinary skilled in the art within the spirit and scope of the present invention.

What is claimed is:

1. An image processing method comprising:
receiving image data represented in an RGB color space;
converting the image data to an HSV color space that includes a hue, a saturation, and a value;
compensating for the image data in the HSV color space on a basis of a hue data of the image data in the HSV color space; and
converting the compensated image data in the HSV color space back to the RGB color space.

2. The method of claim 1, wherein the compensating of the image data in the HSV color space comprises:
reading out a compensation data corresponding to the hue data from a look-up table; and
compensating for the image data in the HSV color space using the compensation data.

3. The method of claim 2, wherein the image data in the HSV color space is compensated for using the equation:
HoSoVo=HnSnVn+dHdSdV,
where HnSnVn denotes the image data in the HSV color space, dHdSdV denotes the compensation data, and HoSoVo denotes the compensated image data in the HSV color space.

4. The method of claim 2, wherein the compensation data comprises hue-difference data, saturation-difference data, and value-difference data.

5. The method of claim 4, wherein the look-up table is a one-dimensional look-up table in which the hue-difference data, the saturation-difference data, and the value-difference data according to the hue data are stored.

6. The method of claim 1, wherein the image data in the HSV color space is compensated when the hue data satisfy a first range.

7. The method of claim 6, wherein the first range is 0°≦H°≦50°, and the H° is obtained by converting the hue data to an angle.

8. The method of claim 6, wherein the first range is 14°≦H°≦28°, and the H° is obtained by converting the hue data to an angle.

9. A display apparatus comprising:
an RGB-to-HSV converter configured to receive image data in an RGB color space and converts the image data in the RGB color space to an HSV color space;
a compensator configured to compensate for the HSV data on a basis of a hue data of the image data in the HSV color space;
an HSV-to-RGB converter configured to receive the compensated image data in the HSV color space and convert the compensated image data in the HSV color space to a compensated image data in the RGB color space; and
a display unit configured to receive the compensated image data in the RGB color space and display an image on a basis of the compensated image data in the RGB color space.

10. The display apparatus of claim 9, further comprising a look-up table that stores a hue-difference data, a saturation-difference data, and a value-difference data according to the hue data.

11. The display apparatus of claim 10, wherein the look-up table is one-dimensional look-up table.

12. The display apparatus of claim 10, wherein the compensator is further configured to read out the hue-difference data, the saturation-difference data, and the value-difference data from the look-up table, which correspond to the hue data, and calculate the hue-difference data, the saturation-difference data, and the value-difference data from the look-up table with the image data in the HSV color space.

13. A method for processing image data, comprising:
receiving image data represented in an RGB color space, the received image data having a first color gamut;
converting the received image data represented in the RGB color space into an HSV color space, the converted image data represented in the HSV color space having a second color gamut that is less robust than the first color gamut;
compensating for changes of skin tone within the converted image data represented in the HSV color space based on a hue data of the converted image data represented in the HSV color space; and
converting the compensated image data represented in the HSV color space back into the RGB color space.

14. The method of claim 13, wherein the compensating of the image data represented in the HSV color space comprises:
reading out a compensation data corresponding to the hue data from a look-up table; and
compensating for the image data represented in the HSV color space using the compensation data.

15. The method of claim 14, wherein the image data represented in the HSV color space is compensated for using the equation:
HoSoVo=HnSnVn+dHdSdV,
where HnSnVn denotes the image data represented in the HSV color space, dHdSdV denotes the compensation data, and HoSoVo denotes the compensated image data represented in the HSV color space.

16. The method of claim 14, wherein the compensation data comprises hue-difference data, saturation-difference data, and value-difference data.

17. The method of claim 16, wherein the look-up table is a one-dimensional look-up table in which the hue-difference data, the saturation-difference data, and the value-difference data according to the hue data are stored.

18. The method of claim 13, wherein skin tone is identified as image data in the HSV color space within a range of 0°≦H°≦50°, where the H° is obtained by converting the hue data to an angle.

19. The method of claim 13, wherein skin tone is identified as image data in the HSV color space within a range of 14°≦H°≦28°, where the H° is obtained by converting the hue data to an angle.

20. The method of claim 13, additionally comprising displaying the compensated image data represented in the RGB color space on a display apparatus.
